(19) United States
(12) Patent Application Publication
(10) Pub. No.: US 2024/0028900 A1
(43) Pub. Date: Jan. 25, 2024

(54) Energy Efficient Computations Using Bit-Sparse Data Representations

(71) Applicant: THE REGENTS OF THE UNIVERSITY OF MICHIGAN, Ann Arbor, MI (US)

(72) Inventors: Hun-Seok KIM, Ann Arbor, MI (US); David BLAAUW, Ann Arbor, MI (US); Dennis SYLVESTER, Ann Arbor, MI (US); Yu CHEN, Ann Arbor, MI (US); Pierre ABILLAMA, Ann Arbor, MI (US); Hyochan AN, Ann Arbor, MI (US)

(73) Assignee: THE REGENTS OF THE UNIVERSITY OF MICHIGAN, Ann Arbor, MI (US)

(21) Appl. No.: 17/872,715

(22) Filed: Jul. 25, 2022

(51) Int. Cl. G06N 3/08; G06F 17/16; G06F 7/544

(52) U.S. Cl. CPC G06N 3/082; G06F 17/16; G06F 7/5443

(57) ABSTRACT

Recent advances in model pruning have enabled sparsity-aware deep neural network accelerators that improve the energy efficiency and performance of inference tasks. SONA, a novel transform-domain neural network accelerator is introduced in which convolution operations are replaced by element-wise multiplications and weights are orthogonally structured to be sparse. SONA employs an output stationary dataflow coupled with an energy-efficient memory organization to reduce the overhead of sparse-orthogonal transform-domain kernels that are concurrently processed while maintaining full multiply-and-accumulate (MAC) array utilization without any conflicts. Weights in SONA are non-uniformly quantized with bit-sparse canonical-signed-digit (BS-CSD) representations to reduce multiplications to simpler additions.

### FIELD

The present disclosure relates to energy efficient computations using bit-sparse data representations particularly suitable for neural networks.

### BACKGROUND

Convolutional neural networks (CNNs) have become a fundamental technique in machine learning tasks, but their extension to low-cost and energy-constrained applications have been limited by CNN model sizes and computational complexity. In recent years, neural network pruning methods aimed at reducing the number of non-zero parameters have been proposed to decrease the model size and lower the computational complexity of convolution and fully connected layers. In turn, sparsity-aware accelerator architectures that directly leverage sparsity have been proposed to improve the energy efficiency of inference tasks by reducing the number of multiply-and-accumulate (MAC) operations and memory accesses.

Another way to reduce complexity is by introducing transform domain computations that reduce the complexity of convolution in CNNs to that of element-wise multiplications. However, it is difficult to combine both techniques since transform-domain neural networks often do not allow aggressive amounts of weight pruning. Applying sparsity-aware aggressive pruning can yield limited observable gains due to the unstructured nature of sparsity. Unstructured sparsity imposes significant overheads and constraints on accelerator flexibility, or results in reduced hardware utilization.

To overcome these challenges, a heterogeneous transform-domain neural network (HTNN) was proposed as a framework to learn structured sparse-orthogonal weights where convolutions are replaced by element-wise multiplications. In an HTNN, two or more kernels in different transform domains share a multiplier without conflict as the non-zero weight positions are strictly orthogonal to each other. Various CNN workloads can be trained, pruned, and quantized in heterogeneous transform-domains while maintaining inference accuracy. However, the expectation that HTNNs can reduce computational complexity compared to equivalent sparse CNNs has not been demonstrated in hardware. Efficiently mapping HTNN models to a hardware architecture in a way that maximizes observable gain remains a significant challenge.

In this disclosure, SONA, a novel energy-efficient hardware accelerator architecture is proposed for HTNNs. At the architecture level, an HTNN-specific output stationary dataflow coupled with an energy-efficient transform memory organization to reduce the overhead of overlapped transform-domain convolution. The proposed architecture demonstrates reconfigurable datapaths to compute the permuted variants of the Walsh-Hadamard transform (WHT) for concurrently executed kernels in the transform domains. Moreover, the sparse-orthogonal weight concept of HTNN is extended to fully connected layers (FCLs) by proposing a column-based block (CBB) structured sparsity pattern. Structured sparsity in FCLs allows SONA to share a unified datapath between sparse convolution and sparse FCLs without compromising MAC array utilization. Furthermore, HTNN employs non-uniformly quantized weights with a bit-sparse canonical signed-digit (BS-CSD) representation. At the circuit level, SONA proposes a novel BS-CSD-MAC unit (CMU) to replace multiplications for weights with bit-shifts and additions.

This section provides background information related to the present disclosure which is not necessarily prior art.

### SUMMARY

This section provides a general summary of the disclosure, and is not a comprehensive disclosure of its full scope or all of its features.

A computer-implemented method is presented for performing computations in a neural network. The method includes: receiving an input patch of data, where the input patch is a vector or a matrix extracted from an input and each element of the vector or the matrix is represented with M digits in accordance with a numeral system; retrieving a kernel of the neural network, where each weight of the kernel is represented with N digits in accordance with a numeral system; and computing a multiplication between elements of the input patch and elements of the kernel of the neural network, where non-zero digits of at least one of the elements of the input patch or the element of the kernel is constrained to less than M or less than N, respectively.

In one aspect, each element of the input patch has a two's complement representation having M bits and each weight of the kernel is quantized as a canonical signed digit with N digits, such that the non-zero digits of the canonical signed digit are constrained to less than N. In this example, a multiplication operation is computed by multiplying a given element of the input patch by sign of each non-zero digit of the cannonical signed digit to yield two products from a first stage; bit shifting products from the first stage in a second stage, where the bit shifting amount is based on position of non-zero digits in the canonical signed digit; and adding products from the second stage together.

In another aspect, each element of the input patch is represented by a sign and magnitude representation with M bits; and each weight of the kernel is represented by a sign and magnitude representation with N bits, such that non-zero bits of at least one of the elements of the input patch or the element of the kernel is constrained to less than M or less than N, respectively. In this example, a multiplication between elements of the input patch and elements of the kernel further is performed by multiplying in parallel elements of the input patch by elements of the kernel using a plurality of multiplier circuits; inputting, from the plurality of multiplier circuits, products with positive results into a positive adder tree circuit; inputting, from the plurality of multiplier circuits, products with negative results into a negative adder tree circuit; and subtracting sum of the negative adder tree circuit from sum of the positive adder tree circuit thereby yielding a final product.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagram showing a comparison between HTNN WHT domain convolution layer and conventional CNN convolutional layer.

FIG. 2 depicts three candidate dataflows for HTNN.

FIGS. 3A and 3B are graphs sowing normalized memory access energy comparison for ConvPool-CNN-C and ResNet-20, respectively, against HTNN loop dataflows.

FIG. 4 is a diagram showing overhead of index-based encoding methods for FCL weight matrices with unstructured sparsity.

FIG. 5 is a diagram of the overall SONA architecture.

FIG. 6 is a

FIG. 7 is a schematic for an 8-bit multiplier circuit.

FIG. 8 is an example of a BS-CSD-MAC unit.

FIG. 9 is diagram showing an arrangement for performing multiplication operations for elements having sign and magnitude representations.

FIG. 10 is schematic of an example embodiment of a sign and magnitude (SM) multiplier circuit.

FIG. 11 is a diagram showing permuted reconfigurable transform datapaths.

FIG. 12 is a diagram depicting MASR transform memory organization for mapping transform activations onto memory banks and words.

FIG. 13 is a diagram showing fully-connected layer paths.

Corresponding reference numerals indicate corresponding parts throughout the several views of the drawings.

### DETAILED DESCRIPTION

Example embodiments will now be described more fully with reference to the accompanying drawings.

First, essential terminology that will be used throughout this disclosure is defined. Additionally, an overview of the 2D WHT is provided along with an explanation of how 2D convolutional layers are replaced by WHT-domain element-wise multiplications in HTNNs. A CNN consists of a set of cascaded layers that includes linear layers such as convolution and non-linear layers such as ReLU. The term activations is used to refer to elements of a given layer's input feature map. The input feature map is of size Nₓ×N_{y}×I_{C}, where Nₓ and N_{y} denote the input feature map's spatial dimensions and I_{C} denotes the layer's number of input channels. The set of learnable parameters in a given linear layer is referred to as weight kernels. The cardinality of this set corresponds to the layer's number of output channels, which is denoted by O_{C}. Each weight kernel is a three-dimensional tensor Kₓ×K_{y}×I_{C} where Kₓ and K_{y} denote the spatial dimensions of the kernel.

Walsh-Hadamard transform (WHT) is a generalized class of Fourier transforms given by a symmetric transform matrix H that contains only binary values ±1. Although WHT-domain convolution is generalizable to kernels of any size, this disclosure focuses on the case where 3×3 convolutions with a stride of 1 are replaced by 4×4 WHT-domain kernels with a stride of 2 given that it is the most common filter configuration in CNNs. Note that the 1×1 point-wise convolution operation is identical in both HTNNs and CNNs.

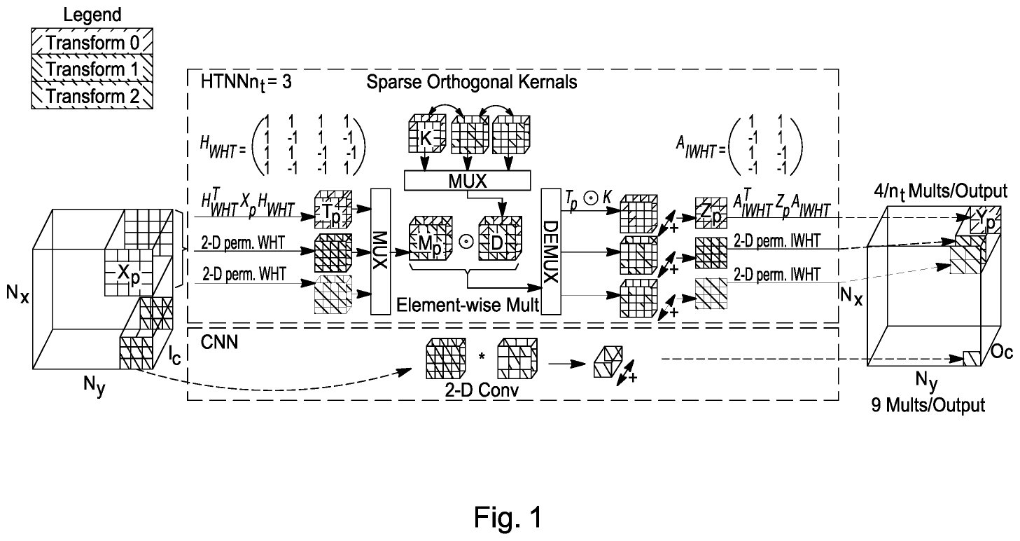

As shown in FIG. 1 on the red path, WHT-domain convolution is based on 4×4×I_{C} activation patches X_{P} extracted from the Nₓ×N_{y}×I_{C} input feature map with a stride of 2×2. To calculate the 2×2 output channel Y_{P} of a layer for patch position p, a 2D 4-point WHT is first applied to each channel in X_{P} to yield T_{P}=H_{WHT}^{T}X_{P}H_{WHT}, where H_{WHT} is the WHT matrix. This 2D WHT can be seen as applying 4-point WHT to the rows and then columns of each channel in X_{P}. Similarly, H_{WHT} would be applied to the corresponding weight kernel. However, a kernel can be trained offline in the WHT-domain, meaning that its transform domain representation K can be directly used during inference without explicit transform computations. Subsequently, each channel in the transform domain kernel K and the WHT representation of X_{P} are multiplied element-wise T_{P}⊙K, and their 4×4×I_{C} intermediate product is reduced to a 4×4 patch Z_{P} by accumulating along the input channels as shown in FIG. 1. After applying the inverse WHT (H_{WHT}⁻¹) to Z_{P}, the output patch Y_{P} is obtained by taking the central 2×2 block of the inverse transform result. Thus the inverse transform can be simplified to applying a 4×2 matrix A_{IWHT} in (1) (i.e., A_{IWHT} ^{T}Z_{P}A^{IWHT}), which corresponds to the middle two columns of H_{WHT}⁻¹. Since the WHT matrix only contains binary values, it can be computed using additions/subtractions. Therefore, compared to a 3×3 convolution that requires 9 multiplications per output activation, the computational complexity is reduced by a factor of 2.25× down to 4 multiplications per output activation by performing the WHT-domain convolution.

To reduce the model size of transform-domain neural networks, the HTNN framework employs nₜ=2 or 3 permuted variants of the WHT to learn structured sparse orthogonal kernels. The matrices corresponding to the WHT permuted variants are obtained by applying a corresponding permutation matrix P to the left of H_{WHT}. Each kernel is associated with a transform variant. In HTNN, nₜ sets of kernels belonging to different transform variants are pruned in such a way that their non-zero values do not overlap. As a result, kernels that are sparse-orthogonal to each other can be overlapped to form a dense overlapped kernel D to process nₜ output channels concurrently as shown in FIG. 1 for nₜ=3. However, to concurrently compute the nₜ 2×2 output channels of a layer for a given patch position p, activation patches X_{P} need to be transformed in nₜ different WHT variants and overlapped using multiplexers to match the overlapping pattern of D. The resulting overlapped activation patches M_{P} are multiplied element-wise with D. The intermediate product's overlapping is then undone with de-multiplexers to accumulate across the input channels for each of the nₜ concurrently computed output channels. Finally, the nₜ accumulated patches are inverse transformed in their respective WHT-domains to recover the nₜ 2×2 output channels.

Canonical-signed-digit (CSD) is a numbering system that uses ternary digits {−1,1,0} to represent an N-bit number such that the number of non-zero digits is minimized. For example, the number 23 requires 4 non-zero digits in the conventional binary representation 010111 but only requires 3 non-zero digits in the CSD representation (1,0,−1,0,0,−1) since 23=2⁵−2³−2⁰ holds. By representing an N-bit weight value using CSD, the number of shift and add operations performed during element-wise multiplications between kernel values k and activation values a are minimized. To further take advantage of the elegant CSD representation, HTNNs impose an additional bit-sparsity constraint to limit the number of non-zero bits in the CSD representation of kernel weight values to at most 2 in order to reduce multiplication to a single addition/subtraction without impacting the inference accuracy. In SONA, N=8-bit input MAC units are implemented for BS-CSD weights that are non-uniformly quantized with at most 2 non-zero digits. Activations are uniformly quantized with N=8 bit two's complement (non-CSD) representation.

Implemented as matrix-vector multiplication between an O_{C}×I_{C} weight matrix W and an I_{C}×1 activation vector a, FCLs constitute a large portion of the weights that can be pruned to sparse matrices. In the context of sparse FCLs, the choice between inner-product or outer-product matrix-vector multiplication can have an impact on the compressed weight representation and the hardware's ability to leverage dynamic activation sparsity. In the case of the inner product, the output of matrix-vector multiplication is computed using a series of dot product operations between a row of W and the entire input activation a. As a result, the weights are compressed along the row and it is difficult to leverage activation sparsity (i.e., element-wise matching and skipping is necessary). In the case of the outer product, the output of matrix-vector multiplication is computed by merging the partial vectors that result from multiplying an entire column of W by one element in a. Therefore, the weights are compressed along the column, which means that we can inherently leverage activation sparsity by employing an input stationary dataflow that detects zero activations and skips entire weight columns that do not contribute to the final result.

In addition, prior works on accelerator architectures optimized for sparse FCLs such as EIE have demonstrated that the location of non-zero weights in W has a significant impact on compute and memory resource utilization. For example, employing a variation of compressed sparse column to encode the non-zero values of W; such an accelerator parallelizes the non-zero multiplications of the matrix-vector operation over 64 processing elements (PE). However, because of the random location of non-zero values and non-uniform sparsity in the FCLs, EIE suffers from two main challenges. The first is load balancing where PEs are assigned a varying number of non-zero weights to multiply the same activation value. Maintaining high utilization requires costly data staging buffers to gather matching pairs. The second is extraneous weight zero padding, which stems from their compressed sparse column scheme. This can lead to inefficient memory utilization and to a sub-optimal number of memory accesses. SONA introduces a new CBB-based structured sparsity pattern to overcome these issues.

Unstructured sparsity leads to a changing number of matching non-zero weight and activation pairs from cycle to cycle such that MAC array utilization becomes unbalanced. In the case of transform domain neural networks with less aggressive pruning ratios, the overhead of unstructured sparsity becomes more noticeable. Mitigating this overhead comes at the cost of increased complexity, for example using large data staging buffers or indexing modules with wide multiplexing logic, which in turn translates to energy inefficiency that overshadows the potential benefits.

Therefore, the proposed SONA architecture is motivated by the drawbacks of existing unstructured sparse DNN accelerator architectures such as SCNN and EIE as well as by the promise of HTNNs. Thus far, the theoretical analysis for HTNN's gain does not address challenges at the hardware level for devising an accelerator architecture that can efficiently exploit the properties of HTNNs to maximize the observable gain. At the architecture level, sparse-orthogonal WHT-domain convolution requires an accelerator with weight and activation memory organizations that cater to the patch-based operation of HTNNs. The architecture's dataflow and memory organization must limit the overhead of WHT-domain computations by reusing the transformed patches across multiple kernels. Performing BS-CSD multiplication requires a different weight representation and additional overhead to determine the variable sign and shift amount of the addition/subtraction operands. Also, HTNNs require multiple WHT variants that can vary depending on the network model.

Note that, despite minimizing the overhead of leveraging weight sparsity of sparse-orthogonal kernels for transform convolution layers, the original HTNN does not provide a framework for learning structured sparsity for FCLs. Moreover, unlike prior sparse CNN accelerators such as SCNN, HTNNs do not leverage activation sparsity in (transform) convolution layers, which makes it more challenging to compete with such designs and unclear whether an accelerator targeting HTNNs can indeed outperform prior designs.

To tackle these challenges, SONA proposes to efficiently map transform-domain neural networks with sparse orthogonal weights onto a hardware accelerator architecture. An HTNN-specific output stationary dataflow is proposed with an energy-efficient memory organization scheme that limits access to only required transformed patches during sparse-orthogonal computations since only 1/nₜ of the transformed patches are used in a cycle to concurrently compute nₜ output channels. A novel BS-CSD MAC unit (CMU) is also proposed to execute element-wise multiplications as well as (inverse) transform datapaths for different permuted variants of the WHT. To address sparse FCLs, one can supplement with a hardware-software co-design framework for learning CBB structured sparse weights, which is a learned index-based weight-encoding representation that maps efficiently onto the proposed accelerator while maintaining full MAC array utilization and without compromising inference accuracy.

The choice of dataflow dictates memory access patterns and therefore plays a significant role in maximizing the efficiency of DNN accelerators. Although CNN accelerator dataflows have been extensively studied, those are not directly transferable to the context of HTNNs because the internal dataflow of heterogeneous transform-domain convolution is dissimilar to that of ordinary convolution. As a result, the choice of heterogeneous transform domain convolution dataflow was studied prior to conceiving SONA.

Let the input feature map, output feature map, and weight kernels be of size N×N×I_{C}, N×N×O_{C}, and O_{C}×I_{C}×4×4, respectively. When the HTNN layer uses nt transform domains, its computation loops over three parameters: patch position p, orthogonal output channels

$$\frac{{O}_{C}}{{n}_{t}}$$

(nₜ orthogonal channels are computed together), and input channels I_{C}. For a candidate architecture, the memory sizes as well as the number of memory accesses along the datapath will depend on the order in which input and output channels are processed.

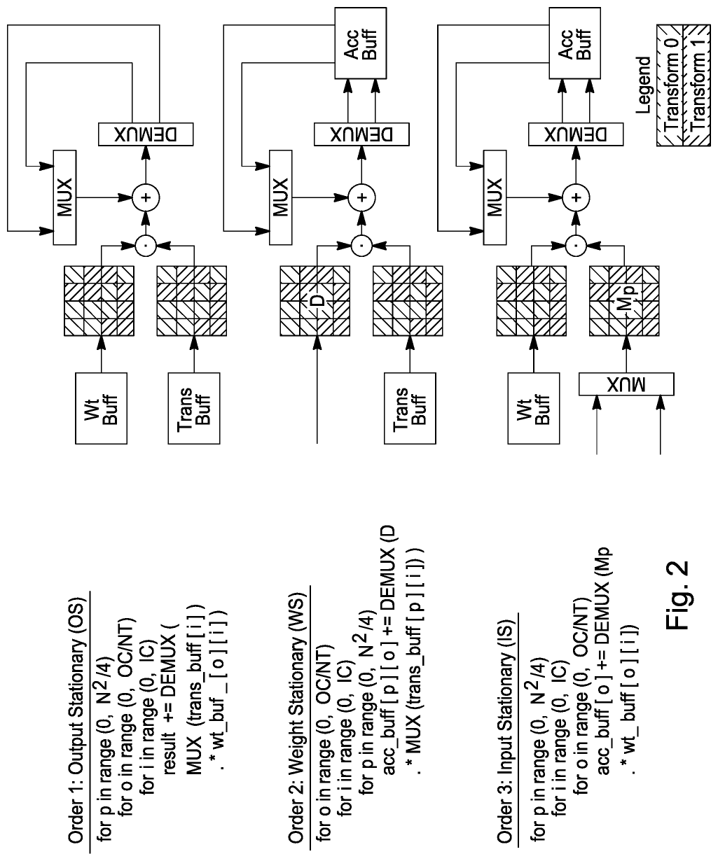

In FIG. 2, three candidate transform-domain convolution dataflows corresponding to different re-orderings of the loops are outlined. The first is output stationary (OS), where the input is processed by applying n t transforms to each input channel patch at a given position. These transformed patches are then reused by multiple weight kernels and are stored in a buffer. Weight kernels are also reused across different patch positions and are stored in a buffer. However, output product patches are accumulated along the input channels, and that can be done locally at the PE level. The second dataflow is weight stationary (WS), where the kernel weight is fixed at the PE level. The input is processed by applying nₜ transforms to all patch positions in a single input channel. These transformed patches are reused by multiple kernels and are therefore stored in a buffer. The third dataflow is input stationary (IS). The input is processed by applying nₜ transforms to a single patch position at a single input channel, meaning there is no buffer for transformed activations. The weight kernels are reused across different patch positions and are stored in a buffer. Finally, in both IS and WS dataflows, accumulation cannot be done locally at the PE level. A buffer is needed to store the output product patches, but the buffer size in IS is smaller than the one in WS.

To identify an energy-efficient dataflow, a case study was performed on transform convolution layers of ResNet-20 and ConvPool-CNN-C. First, quantify the buffer SRAM sizes and the number of read and write accesses in terms of generic layer parameters for the candidate dataflows. Next, outline a memory architecture where each layer of the studied network has on-chip buffer SRAM macros that are sized to fit its layer parameters without needing to tile within the layer, therefore off-chip memory accesses will be identical for all dataflows and are excluded in our comparison. Use TSMC 28 nm memory compilers to obtain unit access energies for SRAM macros. One can also exclude local (PE-internal) register access as its contribution is negligible relative to the SRAM macro access energy contribution.

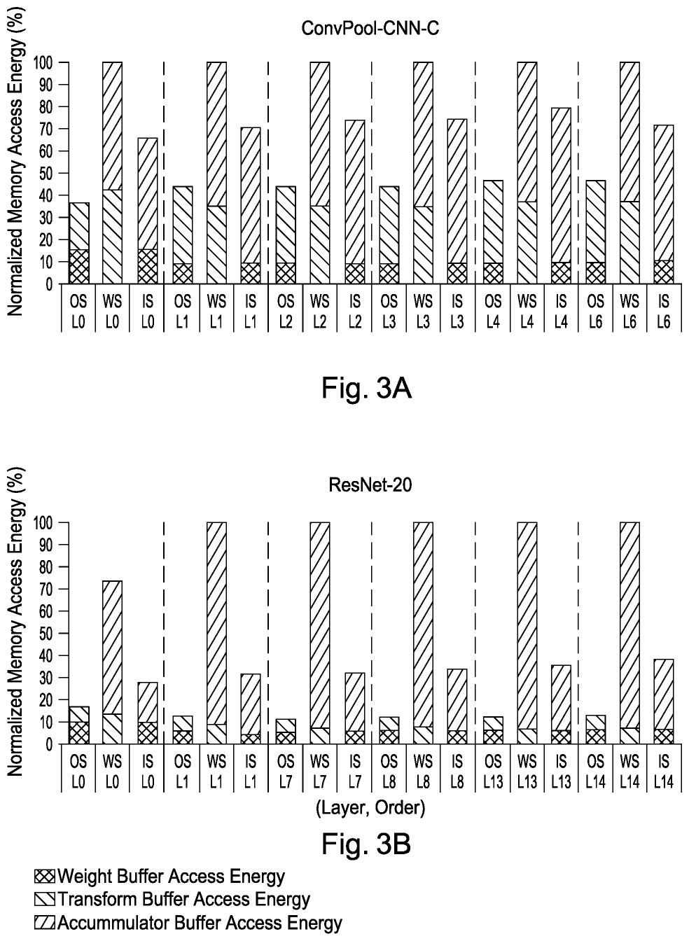

The tradeoffs shown in FIG. 3 in terms of memory access energy cost for each dataflow indicate that the OS dataflow is the most energy efficient for transform-domain convolution. Although a similar observation was made for the conventional CNN dataflow, it is not straightforward to arrive at the same conclusion because the internal dataflow of transform domain convolution that involves element-wise multiplications for the concurrent processing of nₜ sparse-orthogonal kernels is dissimilar to that of ordinary CNNs. WS and IS dataflows are primarily less energy efficient for transform domain convolution because they suffer from a large amount of read-modify-writes, which heavily contribute to the energy cost, whereas accumulations can be done locally at the PE level in the OS dataflow. OS benefits from the fact that the bandwidth of the transform buffer is less than that of the accumulator buffer because only 1/nₜ of the transformed patches are used in a given cycle to concurrently compute nₜ output channels. Despite the write bandwidth of the transform buffer being larger than that of the accumulator buffer, the transform buffer is written to less frequently since the transformed patches are re-used for multiple kernels. To take advantage of these observations, the HTNN-specific OS dataflow requires an efficient memory organization scheme for accessing the transform buffer as will be further described below.

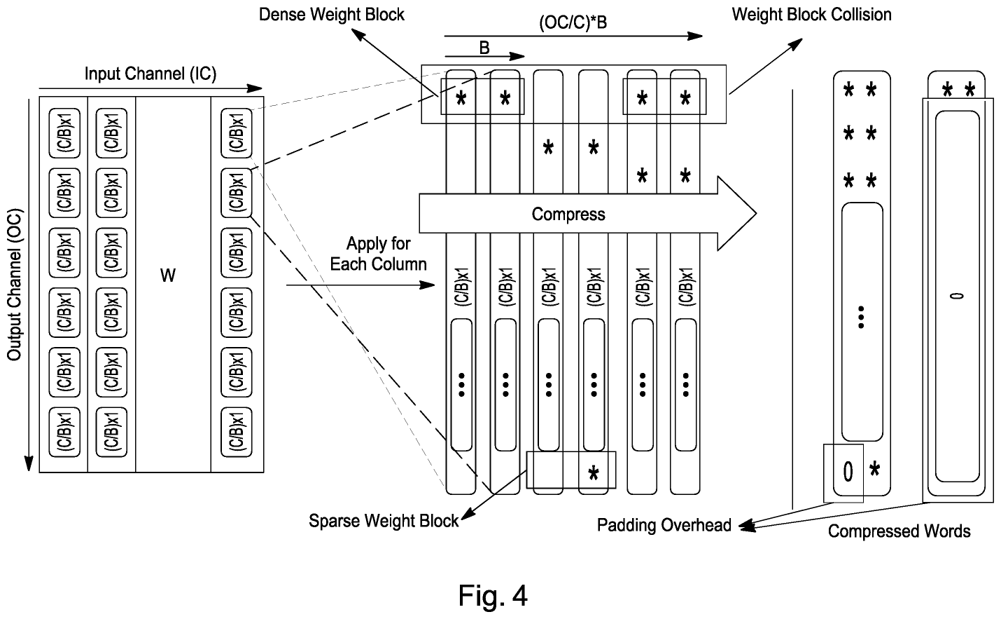

To fully exploit both weight and activation sparsity, an outer-product sparse FCL implementation based on an input stationary dataflow is explored. To best explain the proposed scheme, first consider a case where one employs an index-based compression method to represent the weight matrix W where the location of nonzero weight values are random (unstructured) as illustrated in FIG. 4. First divide the original column into equal-sized chunks of size C/B and reshape the column into a C/B-row matrix, where C is the number of weights in a compressed word and B is the size of a weight block. Then to compress W (remove zeros) along its columns, the weights are packed densely in the direction shown in FIG. 4. Each compressed word contains C/B blocks of weights (i.e., C weights per word). Each weight is associated with the column number that it originates from in the C/B-row matrix. Each weight's position in the compressed word corresponds to its position in the chunk. Despite being able to aggressively prune W, the lack of structure on the location of the zero weights could lead to collisions after reshaping the column. In FIG. 4, the existence of weight block collisions means one may need to have an additional weight word just for one non-zero weight block. Also note the possible existence of non-dense (underutilized) weight blocks. In general, these collisions can be spread across the sparse weight matrix and translate to inefficient memory and MAC utilization.

To combat this inefficiency, a novel CBB structured pruning method is proposed for sparse FCLs that can be learned to minimize the overhead of zero padding while sharing the same hardware with transform-domain convolutions in HTNNs. During FCL training, impose the following sparsity constraint on W. Given a target density d, prune the matrix such that the number of weight block collisions in each row of the reshaped column is the same. As a result, minimize the overall impact of zero padding and maximize the potential memory and MAC utilization. To verify whether CBB structured sparsity can achieve high sparsity ratios while maintaining inference accuracy, the feasibility of this approach was tested on the FCLs of VGG-Nagadomi HTNN. With this scheme, train, prune, and quantize FCL weights using 8-bit BS-CSD in PyTorch with C=64, B=4, and d=6.25% for the CIFAR-10 dataset. The experimental results show that the top-1 accuracy post-training, post-pruning, and post-(BS-CSD) quantization are 92.29%, 92.74%, and 92.22%, respectively. This validates that CBB structured sparsity can be supplemented to HTNNs without compromising the accuracy. CBB structured sparsity can operate at different layer-dependent optimal target densities d (in the range of 6.25-50%) that do not degrade the accuracy by controlling the number of collisions in each row of the reshaped columns of W during training. Parameters C and B are functions of the underlying hardware architecture configuration.

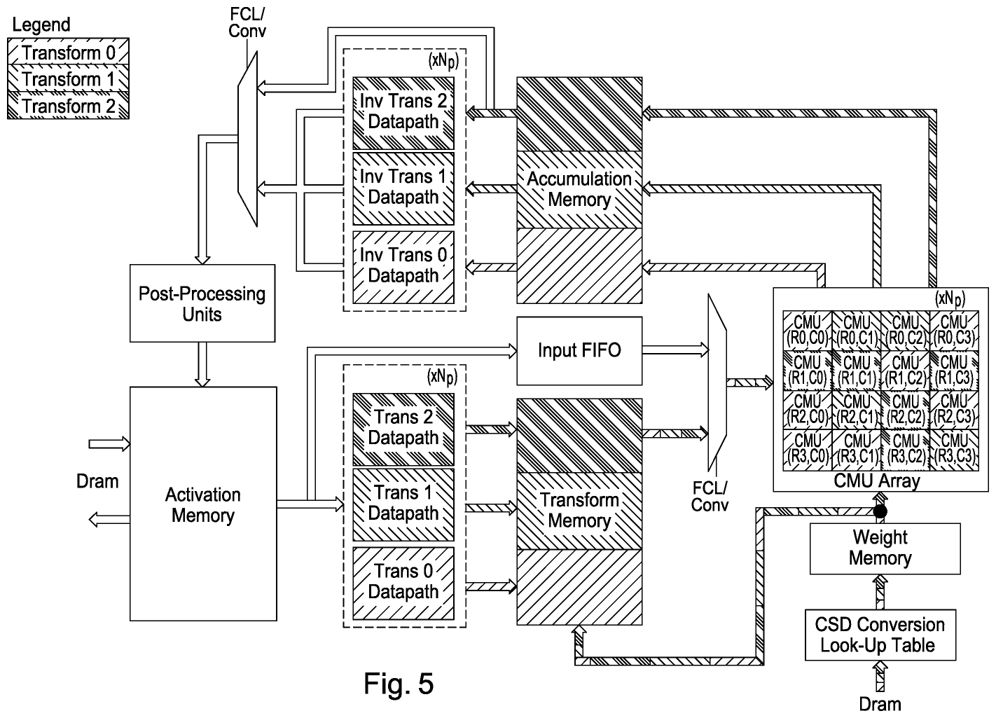

FIG. 5 shows the overall architecture of SONA for processing WHT-domain sparse convolution and sparse FCLs using a unified datapath. All of the weights and activations are initially stored in off-chip DRAM before being loaded into weight and activation memories, respectively. Weights are converted into their BS-CSD representation before being loaded into weight memory. SONA makes use of a 4×4×nₜ BS-CSD-MAC unit (CMU) array and a NP×nₜ transform datapath array to process NP patch positions in parallel using nₜ WHT variants.

The execution of a WHT-domain convolution layer is illustrated in FIG. 5. Paths that are not active during transform convolution are greyed out. Different colors in FIG. 5 indicate nₜ=3 WHT variants with sparse-orthogonal weights that are processed concurrently. The nested-loop control to sweep the patch position, output channels, and input channels follows the OS ordering. Once weights and activations are loaded into their respective memories, an input channel tile of size I for NP 4×4 patches are sent to the transform array. The resulting NP×nₜ transformed 4×4×I patches are stored in transform memory consisting of 4×4×nₜ banks of depth I and data width NP×8 bits. Transform memory organization details are discussed below. Subsequently, SONA performs element-wise BSCSD MAC operations in the CMU array. All NP activation 4×4×I patches are multiplied by the same 4×4×I kernel that merges nₜ sparse-orthogonal weights to concurrently compute nₜ output channels, which are color-coded in FIG. 5. Accumulation across the I channels is done locally at the CMU level (i.e., OS). Upon completing the accumulation for a tile, the following group of orthogonal output channels is processed to maximize the reuse of the transformed activations. If the layer's number of input channels I_{C} is larger than the tile size I, the intermediate result from the previous group of output channels is stored in accumulator memory that consists of 4×4×nₜ banks of depth OC nₜ and data width N_{P}×24 bits. After all the layer's weight kernels and input channels have been processed, N_{P} accumulated 4×4×O_{C} patches are sent to the inverse transform array and post-processing units (e.g., ReLU) while the next set of N_{P} patches are transformed. The final 2×2×O_{C} patches from post-processing are written back to the activation memory.

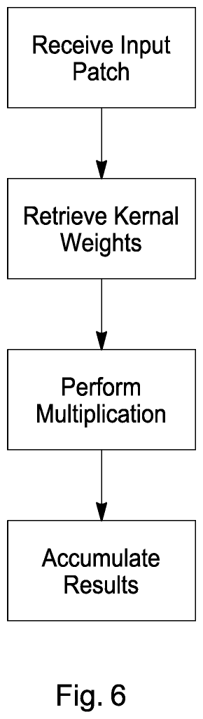

One aspect of this disclosure presents energy efficient computations using bit-sparse data representations. FIG. 6 illustrates a technique for performing computation in a neural network, including the transform-domain neural network accelerator (SONA) described above. More specifically, elements of an input are multiplied by weights of a kernel.

To do so, an input patch of data is received at 61, where the input patch is a vector or a matrix extracted from an input, such as image data from a camera. Each element of the vector or the matrix is represented with M digits in accordance with a numeral system, such as a twos complement representation or a sign and magnitude representation. Next, a kernel of the neural network is retrieved at 62. Likewise, each weight of the kernel is represented with N digits in accordance with a numeral system, such as canonical signed digit or a sign and magnitude representation. Other types of numeral systems are contemplated by this disclosure.

A multiplication operation is then performed at 63 between elements of the input patch and elements of the kernel of the neural network. Of note, non-zero digits of at least one of the elements of the input patch or the elements of the kernel is constrained to less than M or less than N, respectively. That is, at least one of operands has a bit sparse representation. Partial results from each multiplication operation can be accumulated in a register at 64 before feeding the accumulated result to the next layer of the neural network.

In one example embodiment, elements from the input patch are twos complement representations having M bits and the kernel weights are canonical signed digits with N digits, such that the non-zero digits of the canonical signed digit is constrained to less than N. For example, for an 8 digit representation, the non-zero digits are constrained to two or less. The multiplication operation can be implemented by a bit shift operation for each of the two non-zero digits followed by a summation operation.

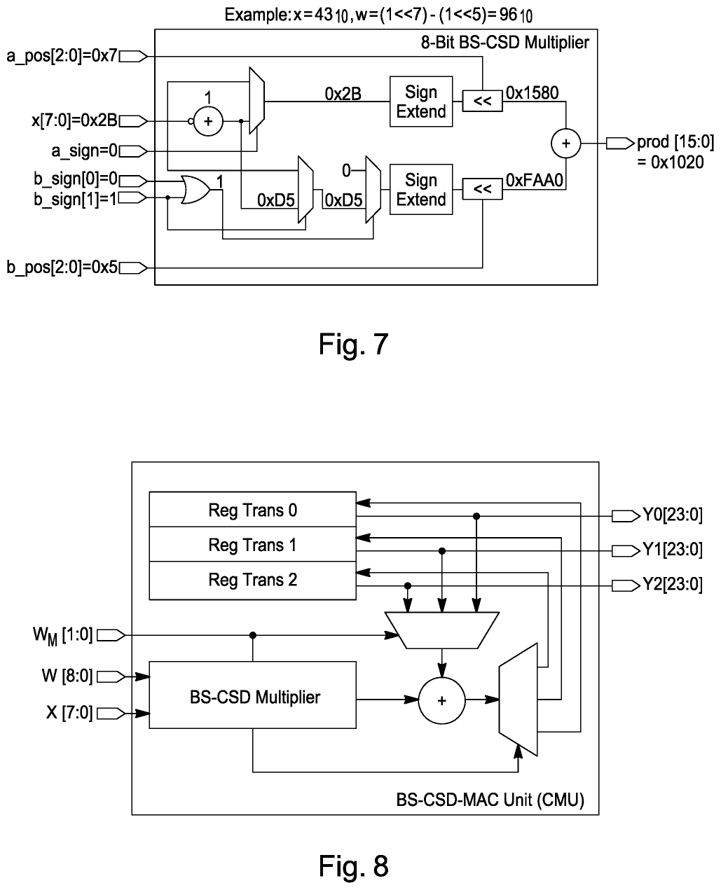

FIG. 7 illustrates an example 8-bit multiplier circuit for performing the multiplication operation. To take advantage of the bit sparsity and non-uniform quantization when performing multiply-and-accumulate (MAC) operations, a hardware-friendly representation is required to represent non-zero weights. Given at most 2 non-zero CSD digits (i.e., bits a and b), encode the respective signs, a_{sign} and b_{sign}, and positions, aₚₒₛ and bₚₒₛ, of these bits to determine the operands of the final addition/subtraction. Without loss of generality, assume that aₚₒₛ>bₚₒₛ (aₚₒₛ∈{0,1, . . . ,7} and bₚₒₛ∈{0,1, . . . ,5}) and encode the traditionally 8-bit weight values w using 9 bits in the form of w=(a_{sign}<<aₚₒₛ)+(b_{sign}<<bₚₒₛ) wherein << denotes the left bit-shift.

This proposed weight representation stems from the observation that the CSD representation of a number does not contain two adjacent non-zero digits. Thus, the relationship between aₚₒₛ and Nos actually becomes aₚₒₛ>bₚₒₛ+1. Taking advantage of the fact that there are 87 quantization levels (byproduct of having non-zero digits) one can reduce the memory footprint in off-chip memory by storing each weight as a 7-bit code, which can be converted to a 9-bit representation using a look-up-table before storing it in SONA's weight memory. FIG. 7 illustrates an example multiplication where x=43 and w=(1,0,−1,0,0,0,0,0)=96. Using the proposed representation, multiplication between an 8-bit activation and BS-CSD weight is replaced by two bit-shifts and one 16-bit addition. Note how the final 16-bit adder at the end of the multiplier requires prior additional shifting and multiplexing logic to generate partial products based on the sign and position of each non-zero digit of the weight.

In summary, the multiplication operation is achieved by multiplying a given element of the input patch by sign of each non-zero digit of the cannonical signed digit to yield two products in a first stage; bit shifting products from the first stage in a second stage, where the bit shifting amount is based on position of non-zero digits in the canonical signed digit; and adding products from the second stage together. Furthermore, the circuit in FIG. 7 can be generalized to any bitlength for the input patch of data. As for the bitlength of kernel weight, the same circuit can be used for any bitlength so long as the number of non-zero ternary digits in the canonical signed digit representation of the weight is at most 2. The equivalent two's complement binary representation for those weights can be of any bitlength. For example, 4095 is a 12 bit weight but in CSD it can be represented using only 2 ternary digits (1, 0, 0, 0, 0, 0, 0, 0, 0, 0, 0, −1, 0)=2\hat{ }12−2\hat{ }1 so the circuit can be used to multiply any activation by this kind of weight. Although the circuit shows the implementation for 8-bit activations (input patch of data) and 8-bit weights, it can be generalized for M bit activations. In this case, x[7:0] becomes x[M−1:0]. If one generalizes to N-bit weights with at most 2 non-zero ternary digits in the equivalent CSD representation, then a_pos[2:0] becomes a_pos[ceil(log 2(N))−1:0] and b_pos[2:0] becomes b_pos[ceil(log 2(N))−1:0]. The circuit remains the same.

SONA employs 4×4×N_{P} BS-CSD-MAC units (CMUs) shown in FIG. 8 to perform dense (after merging nₜ sparse orthogonal weights) element-wise multiplications where N_{P} is the number of patch positions processed in parallel. In each cycle, a single 8-bit BS-CSD multiplier and a single 24-bit accumulation adder perform at most one non-zero and nₜ−1 implicit zero MAC operations. The inputs to the unit are the 8-bit two's complement activation x, the 9-bit BS-CSD weight w and a 2-bit weight mask wₘ indicating the transform variant associated with w. Each weight is associated with a unique weight mask used to perform muxing/demuxing as the orthogonal overlapping pattern varies from channel to channel. The partial results are accumulated locally in registers that map to the concurrently computed nₜ output channels.

In another example embodiment, elements from the input path have sign and magnitude representations with M bits and the kernel weights also have sign and magnitude representations with N bits. Of note, non-zero bits of at least one of the elements of the input patch or the element of the kernel is constrained to less than M or less than N, respectively. Sign and magnitude representation (SMR) is more efficient than twos complement representation (2CR) in terms of energy consumption of multiplication. The energy consumption is related to the number of toggle activity for completing multiplication operations. More specifically, when sign of the number is negated in 2CR, many bits need to be toggled. On the other hand, only one sign bit can be changed in SMR. This characteristics of two different representation methods are critical in multiplication operation. Multiplication is calculated by adding multiple partial products, which involves excessive toggle activities in 2CR.

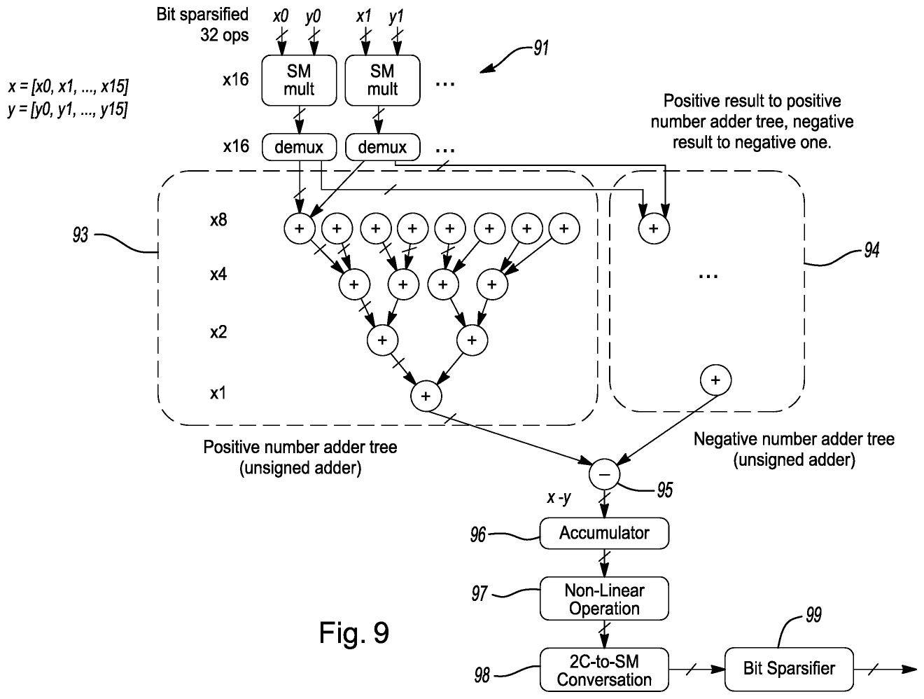

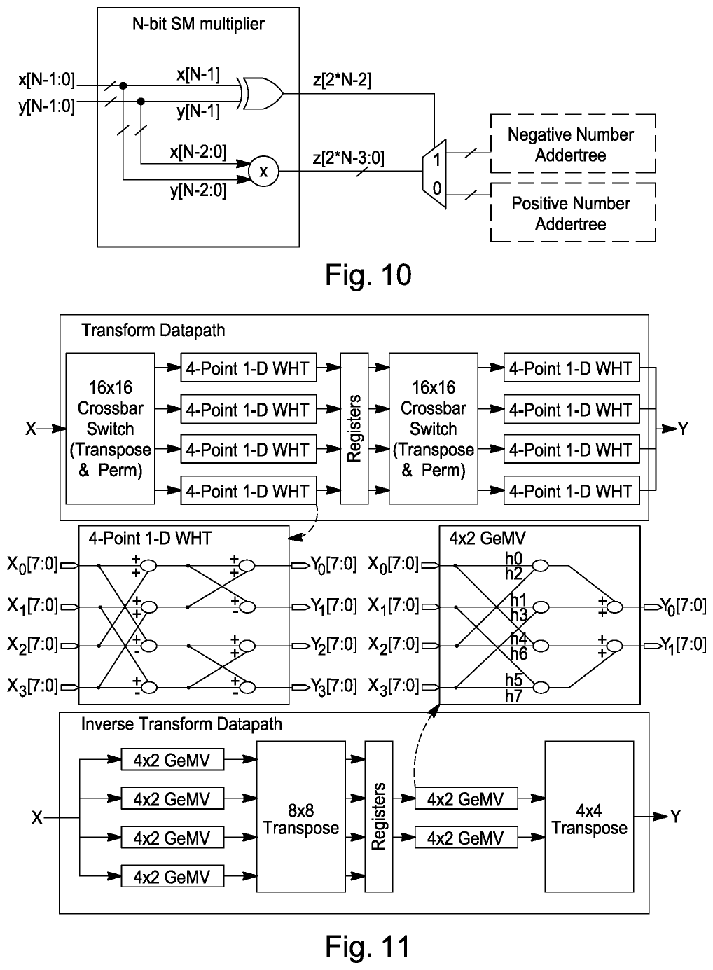

FIG. 9 illustrates an example implementation for performing multiplication operations between the elements of the input patch and the kernel weights, each the input elements and the kernel weights have sign and magnitude representations. First, numerous multiplication operations are performed in parallel by a plurality of multiplier circuits 91. For example, 16 elements of an input patch may be multiplied concurrently with 16 kernel weights. An example embodiment of a sign and magnitude (SM) multiplier circuit is shown in FIG. 10. Other designs for the multiplier circuit also fall within the scope of this disclosure.

Output from the SM multiplier circuits 91 are in turn feed into one of two adder tree circuits 93, 94. More specifically, products from the SM multiplier circuits with positive results are input into a positive adder tree circuit 93 and products from the SM multiplier circuits with negative results are input into a negative address tree circuit 94. Sum from the negative adder tree circuit is subtracted from the sum of the positive adder tree circuit at 95 to thereby yield a final product. In some cases, the size of the input patch may exceed the number of SM multipliers and partial results from the adder tree circuit are accumulated in an accumulator 96.

Prior to inputting the final product into the next layer of the neural network, the final product undergoes non-linear operations at 97 as well as a conversion from a twos complement representation to a sign and magnitude representation at 98. To ensure lower energy consumption in subsequent layers of the neural network, the final product also undergoes a bit sparse operation at 99. The bit sparse operation is preferably performed immediately before the next layer although it is possible to feed bit spares inputs in the non-linear operations.

Returning to the description for the SONA architecture, the reconfigurable transform datapaths need to handle different permuted variants of the 2D WHT, which are defined as H_{P}=PH_{WHT} where P is the corresponding permutation matrix. A 4×4 2D non-permuted fast WHT requires 8×8=64 adders/subtractors. The transform operation can be reordered and split into two back-to-back identical operations as in Y=H_{P}^{T}XH^{P}=(((X^{T}P)H_{WHT})^{T}P) H_{WHT}. First, the 4×4 input patch X is transposed and permuted. A transform is then applied to each row of the intermediate result. The operation is repeated a second time to produce the final transformed patch Y. A diagram of the proposed transform datapath is shown in FIG. 11 (top). The transpose and permutation operations are combined into a single 16×16 reconfigurable crossbar switch. To implement the permuted variants of the inverse WHT operation as defined in Y=A_{P}^{T}XA_{P}, one might note that H_{WHT} is an orthogonal matrix and that one can reuse the WHT transform datapath in FIG. 11 (top) to compute the inverse WHT. However, this would be wasteful as we only need the central 2×2 block from the resulting operation. The permuted inverse WHT variants (A_{P}) correspond to the binary-valued (±1) middle two columns of the H_{P}−1 matrices. Therefore, the inverse transform is implemented using reconfigurable 4×2 general matrix-vector (GeMV) multiplication blocks and transpose interconnect networks as shown in FIG. 11 (bottom). Each datapath requires 6×6=36 adders/subtractors. SONA employs nₜ×N_{P} datapaths for each of the transform and inverse transform to process N_{P} individual 4×4 patches using up to nₜ variants in parallel. These datapaths are pipelined to ensure that they do not limit the performance of the overall architecture.

Overlap nₜ≤3 orthogonal weight kernels prior to storing them in weight memory and associate with each weight a 2-bit mask to indicate its corresponding WHT variant. The input activation patches are transformed in all nₜ variant domains and re-used across the output channel dimension, but only 1/nₜ are used during element-wise multiplications. It must be noted that the overlapping pattern is different from channel to channel within a single layer, which makes reusing transformed patch nontrivial. Therefore, it is critical to devise an energy-efficient transform memory organization that limits the access to only the required transformed patches in each cycle.

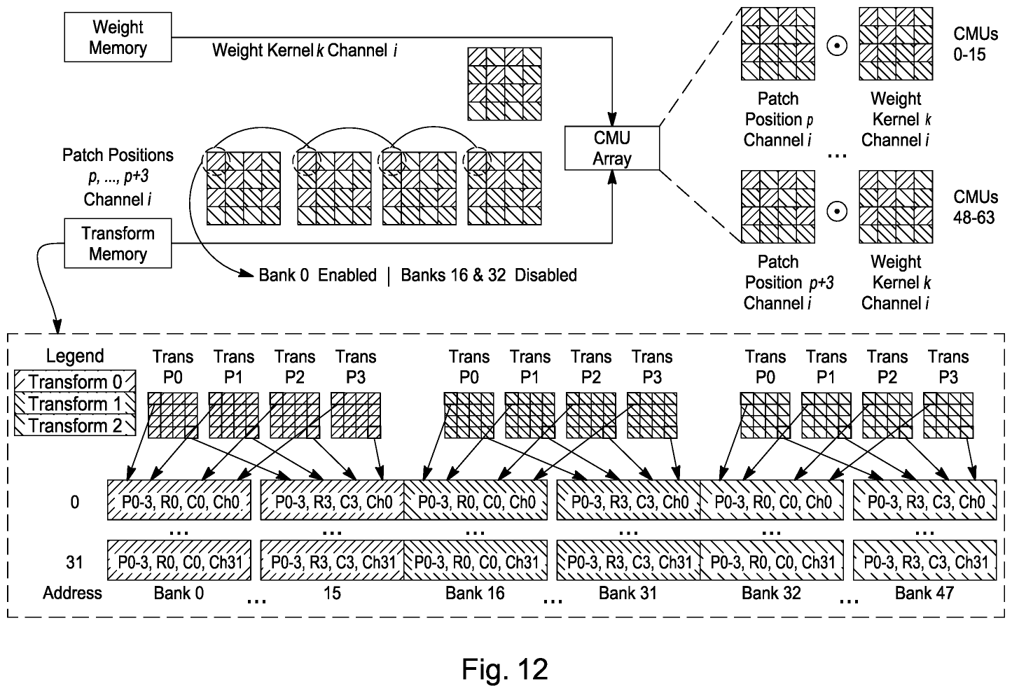

Assuming that one processes N_{P} patches in parallel, the transform memory is expected to hold I×N_{P} 8-bit transformed activation patches where I is the tile size for the number of input channels. The read and write bandwidths of this memory are 4×4×N_{P} and 4×4×N_{P}×nₜ, respectively. One approach referred to as single patch single row (SPSR) consists of having N_{P}×nₜ banks of depth I and word width 4×4×8 bits. Another approach referred to as single activation single row (SASR) consists of having N_{P}×nₜ×4×4 banks of depth I and word width 8 bits. SASR provides more flexibility than SPSR in controlling which activations are read during a cycle. With SPSR, nₜ×N_{P} patches are read when only N_{P} patches are needed. In other words, SASR helps limit the number of unnecessary memory accesses. However, SASR incurs a larger overhead for peripheral memory circuitry from employing many more smaller banks and therefore has the potential to be less area and energy efficient than SPSR. As a compromise, a multiple activation single row (MASR) scheme is proposed as illustrated in FIG. 12. MASR has nₜ×4×4 banks of depth I and word width N_{P}×8 bits. This approach was chosen since the overlap pattern is solely dependent upon the kernel being processed and all N_{P} patch positions are multiplied by the same kernel in a cycle. When loading the transformed patches from transform memory, the weight mask can be used to disable

$$\frac{{n}_{t} - 1}{{n}_{t}}$$

of the banks and load only the N_{P} overlapped transformed patches that are needed. In FIG. 12, MASR is shown for I=32, N_{P}=4, nₜ=3. The top left weight of the loaded kernel is associated with variant 0, and all the activations of each transformed patch using variant 0 are in bank 0. For element-wise multiplication, we enable that bank and disable the other two that contain the activations transformed using variants 1 and 2 at that location.

Experimental results using Arm memory/register file compilers in TSMC 22 nm technology indicate that for I=32, MASR has {1.2×,1.7×} and {1.6×,2.4×} less access energy than SPSR and SASR, respectively, for N_{P}={2,4} at the cost of being {1.8×,1.3×} less area efficient than SPSR. Note that SASR is overall the most flexible but least area efficient approach and it is not necessarily energy efficient as the increased number of small memory banks incurs energy overhead to peripheral circuitry for memory banking. Thus to exploit patch parallelism, MASR becomes necessary to maximize the energy efficiency of the design.

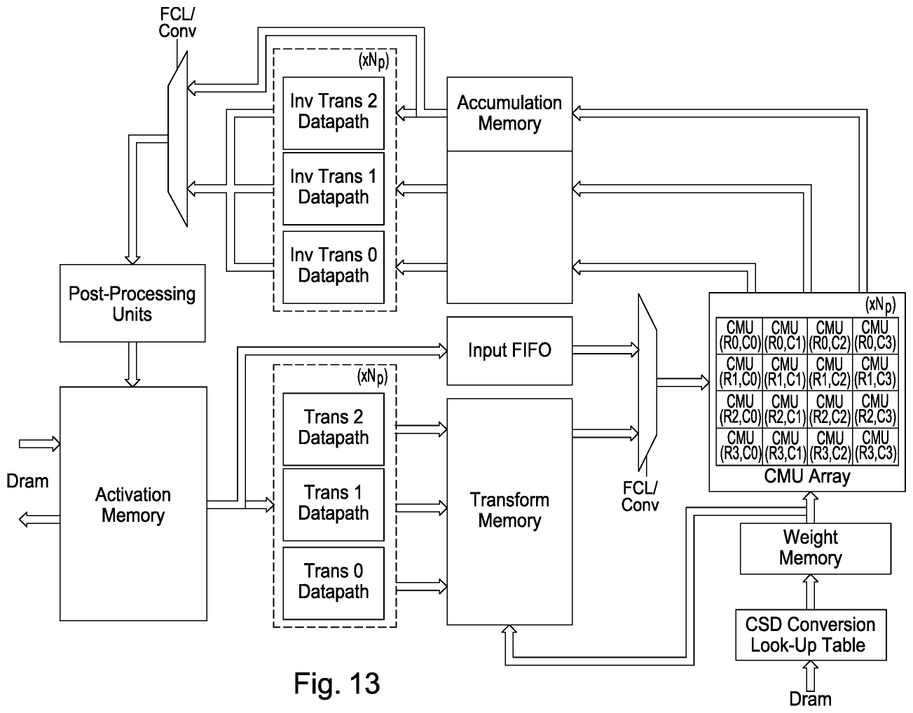

The execution of an FCL is illustrated in FIG. 13, where inactive paths related to transform-domain convolution are greyed out. As discussed above, an input stationary dataflow is employed for FCLs where only non-zero activation values in the input FIFO are detected and broadcast to the CMU array. In addition, implement outer-product matrix vector multiplication for the full CMU array utilization using only 1/nₜ of the accumulator memory banks. CBB structured sparse weights are represented using the proposed index based encoding method. CBB structured sparsity parameters C and B are selected in conjunction with the SONA architecture configuration parameter N_{P} and the 4×4 patch-based dataflow. To share the datapath between transform-domain convolution and sparse FCL without degrading MAC array utilization, we select C=4×4×N_{P} and B=N_{P}. Each one of the 4×4 utilized accumulator memory bank maps to one of the C/B rows in the reshaped columns of W shown in FIG. 4. Each weight block maps to an address in an accumulator memory bank. The maximum number of output channels supported for an FCL is bounded by 4×4×N_{P}×O_{C}/nₜ where O_{C}/nₜ is the depth of an accumulator memory bank.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for performing computations in a neural network, comprising:
receiving, by a computer processor, an input patch of data, where the input patch is a vector or a matrix extracted from an input and each element of the vector or the matrix is represented with M digits in accordance with a numeral system;
retrieving, by the computer processor, a kernel of the neural network, where each weight of the kernel is represented with N digits in accordance with a numeral system; and
computing, by the computer processor, a multiplication between elements of the input patch and elements of the kernel of the neural network, where non-zero digits of at least one of the elements of the input patch or the element of the kernel is constrained to less than M or less than N, respectively.

2. The method of claim 1 wherein each element of the vector or the matrix is a two's complement representation having M bits and each weight of the kernel is quantized as a canonical signed digit with N digits, such that the non-zero digits of the canonical signed digit are constrained to less than N.

3. The method of claim 1 wherein each element of the vector or the matrix is represented by a sign and magnitude representation with M bits; and each weight of the kernel is represented by a sign and magnitude representation with N bits, such that non-zero bits of at least one of the elements of the input patch or the element of the kernel is constrained to less than M or less than N, respectively.

4. A computer-implemented method for performing computations in a neural network, comprising:
receiving, by a computer processor, an input patch of data, where the input patch is a vector or a matrix extracted from an input and each element of the vector or the matrix is represented by a binary number;
retrieving, by the computer processor, a kernel of the neural network, where each weight of the kernel is quantized as a canonical signed digit with N digits and non-zero digits of the canonical signed digit are constrained to less than N;
computing, by the computer processor, a multiplication between elements of the input patch and elements of the kernel of the neural network.

5. The method of claim 4 wherein each element of the vector or the matrix is a two's complement representation having M bits.

6. The method of claim 4 wherein each kernel weight is further defined as a canonical signed digit with 8 bits and no more than two non-zero digits and each element of the matrix is a two's complement representation with 8 bits.

7. The method of claim 6 wherein each multiplication is implemented by a bit shift operation for each of the two non-zero digits followed by a 16 bit addition operation.

8. The method of claim 6 wherein computing a multiplication operation includes
multiplying a given element of the input patch by sign of each non-zero digit of the cannonical signed digit to yield two products from a first stage;
bit shifting products from the first stage in a second stage, where the bit shifting amount is based on position of non-zero digits in the canonical signed digit; and
adding products from the second stage together.

9. The method of claim 4 further comprises accumulating partial results from multiplying the elements of the input patch by elements of the kernel in a register and feeding the accumulated results to a next layer of the neural network.

10. A computer-implemented method for performing computations in a neural network, comprising:
receiving, by a computer processor, an input patch of data, where the input patch is a vector or a matrix extracted from an input and each element of the vector or the matrix is represented by a sign and magnitude representation with M bits;
retrieving, by the computer processor, a kernel of the neural network, where each weight of the kernel is represented by a sign and magnitude representation with N bits; and
computing, by the computer processor, a multiplication between elements of the input patch and weights of the kernel of the neural network, where non-zero bits of at least one of the elements of the input patch or the element of the kernel is constrained to less than M or less than N, respectively.

11. The method of claim 10 wherein each multiplication is implemented by a sign and magnitude multiplier circuit.

12. The method of claim 10 wherein computing a multiplication between elements of the input patch and elements of the kernel further comprises
multiplying in parallel elements of the input patch by elements of the kernel using a plurality of multiplier circuits;
inputting, from the plurality of multiplier circuits, products with positive results into a positive adder tree circuit;
inputting, from the plurality of multiplier circuits, products with negative results into a negative adder tree circuit; and
subtracting sum of the negative adder tree circuit from sum of the positive adder tree circuit thereby yielding a final product.

13. The method of claim 12 further comprises accumulating final products, computing a non-linear layer on the accumulated final products, representing each non-linear layer output in a sign and magnitude form with M bits, processing the output with a bit sparsification circuit that reduces the number of non-zero bits to less than M, and feeding the result to a next layer of the neural network.
